(19) United States
(12) Patent Application Publication
(10) Pub. No.: US 2026/0280709 A1
(43) Pub. Date: Sep. 17, 2026

(54) OPTICAL GROUND STATION FOR SATELLITE COMMUNICATION

(71) Applicant: HITEC Luxembourg S.A., Mamer (LU)

(72) Inventors: Yves LEINER, Bergem (LU); Marc GUEVEL, Rehlingen-Siersburg (DE)

(21) Appl. No.: 19/469,658

(22) PCT Filed: Apr. 10, 2024
(86) PCT No.: PCT/EP2024/059724

§ 371 Date: Sep. 26, 2025

(30) Foreign Application Priority Data
Apr. 27, 2023 (LU) 504085

(51) Int. Cl. H04B 10/118

(52) U.S. Cl. CPC H04B 10/118

(57) ABSTRACT

An optical ground station for satellite communication may include a base with a bearing support. An intermediate frame is mounted on the base, the intermediate frame having a circular-arc-shaped guide engaged with the bearing support so as to allow angular motion of the intermediate frame about a first, (substantially) horizontal, axis corresponding to the axis of the circular-arc-shaped guide. A first actuator is configured and arranged to rotate the intermediate frame relative to the base about the first axis. An optical communication terminal is mounted to the intermediate frame through a rotary bearing allowing angular motion of the optical communication terminal about a second axis perpendicular to the first axis. A second actuator is configured and arranged to rotate the optical communication terminal relative to the intermediate frame about the second axis.

### BACKGROUND

The present disclosure generally relates to ground-satellite uplink and/or downlink optical communication technology.

A conventional mount type for LEO satellite tracking is the azimuth-elevation (also: altazimuth) gimbal mount. An azimuth-elevation mount has one gimbal that provides 360-degree motion in azimuth and a second gimbal that provides 90-degree rotation in elevation (altitude). When a satellite travels through the zenith of (i.e., directly overhead) the ground station, the azimuth gimbal is required to instantaneously rotate through 180 degrees. Even when a satellite passes only near the zenith, the azimuth gimbal must turn very rapidly, giving rise to high accelerations and making it challenging to track the satellite with high precision.

The above keyhole or singularity problem is known for the tracking of satellites with directional RF antennas. U.S. Pat. No. 6,285,338 provides two approaches for eliminating the keyhole problem associated with an azimuth-elevation gimbal antenna, which occurs when the tracked satellite passes through a near zenith position. A first approach involves tilting up one of the elevation axis joints when the antenna points at or near its zenith position such that the pointing angle may be altered by a predetermined angle, for example around 0.5° to 1°, from the zenith position. A second approach involves tilting the secondary reflector of the Cassegrain antenna such that the pointing direction of the antenna may be altered by a predetermined angle.

US 2017/366264 A1 relates to a portable optical ground station that can track a satellite with an amateur telescope mounted on a two-axis gimbal. The telescope is aligned with respect to an inertial, Earth-fixed frame using a wide field of view star camera. Using multiple star sensor measurements at different gimbal angles, it is possible to calculate the alignment of the gimbals in the Earth-fixed frame and the alignment of the star sensor in the gimbal frame. Once the alignment is obtained, satellite tracking can be achieved with a known orbit and precise Earth rotation model, such as the International Earth Rotation and Reference System Service (IERS). Purportedly, the alignment procedure can be conducted in less than one hour, making it practical to move and deploy the portable ground station. US 2017/366264 A1 mentions the keyhole problem and notes that, unfortunately for altazimuth mounts, zenith passes correspond with the shortest link range and therefore the most favorable link conditions. US 2017/366264 A1 concludes that, although high elevation passes are rare, the mount should be capable of fast slews to ensure the link can be maintained near the singularity.

### SUMMARY

The present disclosure relates to an optical ground station for improved tracking of low-Earth-orbit (LEO) satellites. More specifically, the present disclosure relates to ground station with a two-axis gimbal mount for pointing an optical communication terminal to a satellite. According to a first aspect of the present disclosure, an optical ground station for satellite communication is proposed. The optical ground station comprises:
a base with a bearing support;
an intermediate frame mounted on the base, the intermediate frame comprising a circular-arc-shaped guide engaged with the bearing support so as to allow angular motion of the intermediate frame relative to the base about a first, (substantially) horizontal, axis corresponding to the axis of the circular-arc-shaped guide;
a first actuator configured and arranged to rotate the intermediate frame relative to the base about the first axis;
an optical communication terminal mounted to the intermediate frame with a rotary bearing allowing angular motion of the optical communication terminal about a second axis perpendicular to the first axis, the second axis being fixed relative to the intermediate frame (and thus capable of rotating with the intermediate frame about the first axis); and
a second actuator configured and arranged to rotate the optical communication terminal relative to the intermediate frame about the second axis.

The circular-arc-shaped guide preferably forms an incomplete circle (C-guide), with an angular opening preferably dimensioned such that the optical communication terminal is not impeded in its rotation about the second axis and/or such that the field of view of the optical communication terminal is not restricted.

In the context of the present document, the first and second axes are considered to be perpendicular if (and only if) their respective direction vectors are perpendicular. It is thus possible, but not necessary that the first and second axes intersect (at right angle). Preferably, each one of the first and the second axes is balanced, i.e., the center of mass of the components capable of rotating about the second axis lies on the second axis and the center of mass of the components capable of rotating about the first axis (which includes the components capable of rotating about the second axis) lies on the first axis. Accordingly, if the first and the second axes intersect and if the second axis is balanced, this implies that the intermediate frame needs to be balanced about the first axis. However, this may, in practice, be difficult to achieve or make it necessary to use counterbalancing weights, which come at the price of higher inertia of the system.

Preferably, the second axis is thus offset from the first axis, i.e., the first and second axes are skew lines (but perpendicular in the above sense) and separated by a perpendicular distance. The optical communication terminal may be mounted on the second axis in a balanced manner. The perpendicular distance between the first and second axes may then be chosen such that the center of mass of the components capable of rotating about the first axis (which includes the components capable of rotating about the second axis) lies on the first axis. In other words, the perpendicular distance may be chosen such that the mass of the components capable of rotating about the second axis (essentially) compensates any offset between the center of mass of the intermediate frame and the first axis.

It will be appreciated that the optical ground station mounts the optical communication terminal in a so-called X/Y configuration rather than in an altazimuth configuration. It may be noted that the X/Y configuration also has singularities, but these are located on the horizon (in particular on the first axis), where no optical link is established (for geographical and/or atmospheric reasons). However, for high elevations, i.e., when the conditions for optical communication are typically optimal (shortest optical path through the atmosphere), the X/Y configuration offers smooth dynamics.

The first actuator may comprise a curved (arc-shaped) linear motor.

The optical ground station may comprise a scale encoder (i.e., a scale that encodes position paired with a sensor capable of reading the scale and translating the reading into an analog or digital signal) for reading the angular position of the intermediate frame relative to the base and providing a feedback signal to the curved linear motor or its controller. The scale encoder may be of the incremental type or of the absolute type.

The second actuator preferably comprises a servomotor (with an encoder for angular position feedback), more preferably a direct drive servomotor.

The optical communication terminal may comprise a telescope or a set of plural telescopes. Each telescope may be adapted to a different satellite or constellation of satellites. By onboarding plural telescopes, the ground station may thus be used for different satellites or constellations. Since, at a given position on Earth, the passes of LEO satellites last only a few minutes (e.g., between 5 and 15 minutes), the capability of the ground station to track different satellites may significantly reduce downtime.

The optical ground station may comprise a controller operatively connected with the first and second actuators for controlling the pointing direction of the optical communication terminal.

The first axis may be oriented in the North-South direction or in the East-West direction. The orientation of the first axis may be chosen depending on the orbits of the satellites to track.

The optical ground station is preferably configured such that the intermediate frame may be rotated at least 160°, more preferably at least 170° and most preferably at least 180°, about the first axis. Additionally, or alternatively, the optical ground station may be configured such that the optical communication terminal may be rotated at least 160°, more preferably at least 170° and most preferably at least 180° about the second axis. Since it is unlikely that a satellite would be acquired below 10° elevation, the angular ranges of 160° may be sufficient on most sites.

A further aspect of the present disclosure relates to a method of communicating with a LEO satellite using an optical ground station as described herein, the method comprising pointing the optical communication terminal to the satellite and tracking the satellite by maintaining the optical communication terminal pointed to the satellite as the satellite follows its trajectory.

As used herein, the expression “substantially horizontal” includes horizontal (i.e., perpendicular to the vertical) and small deviations (up to ±15°) from horizontal, at the location of the ground station.

In the present document, the verb “to comprise” and the expression “to be comprised of” are used as open transitional phrases meaning “to include” or “to consist at least of”. Unless otherwise implied by context, the use of singular word form is intended to encompass the plural, except when the cardinal number “one” is used: “one” herein means “exactly one”. Ordinal numbers (“first”, “second”, etc.) are used herein to differentiate between different instances of a generic object; no particular order, importance or hierarchy is intended to be implied by the use of these expressions. Furthermore, when plural instances of an object are referred to by ordinal numbers, this does not necessarily mean that no other instances of that object are present (unless this follows clearly from context). When this description refers to “an embodiment”, “one embodiment”, “embodiments”, etc., this means that the features of those embodiments can be used in the combination explicitly presented but also that the features can be combined across embodiments without departing from the present disclosure, unless it follows from context that features cannot be combined.

### BRIEF DESCRIPTION OF THE DRAWINGS

By way of example, preferred, non-limiting embodiments of the present disclosure will now be described in detail with reference to the accompanying drawings, in which:

FIG. 1: is a schematic perspective view of an optical ground station according to an embodiment of the present disclosure;

FIG. 2: is a first elevation view of the optical ground station of FIG. 1;

FIG. 3: is a second elevation view of the optical ground station of FIG. 1;

FIG. 4: is an enhanced view of a detail of FIG. 3, showing how the intermediate frame is mounted on the bearing support.

### DETAILED DESCRIPTION

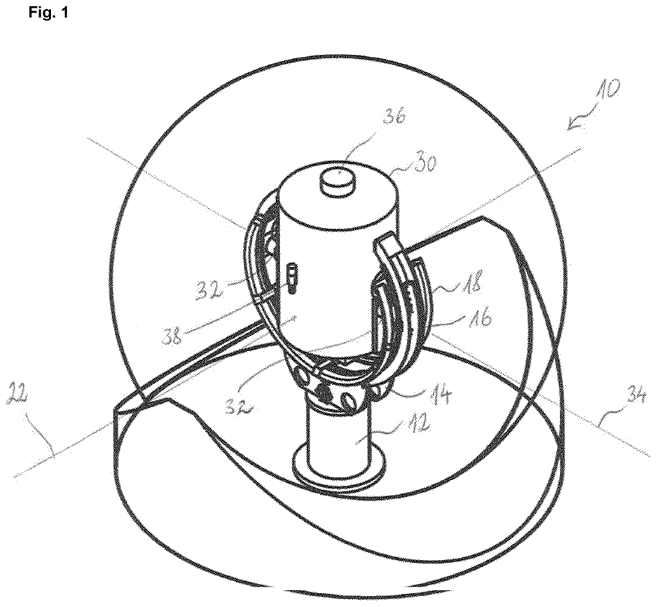

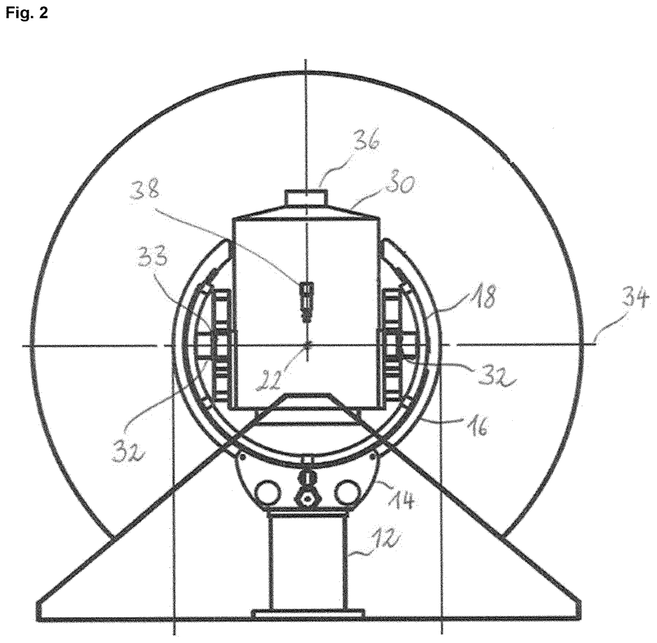

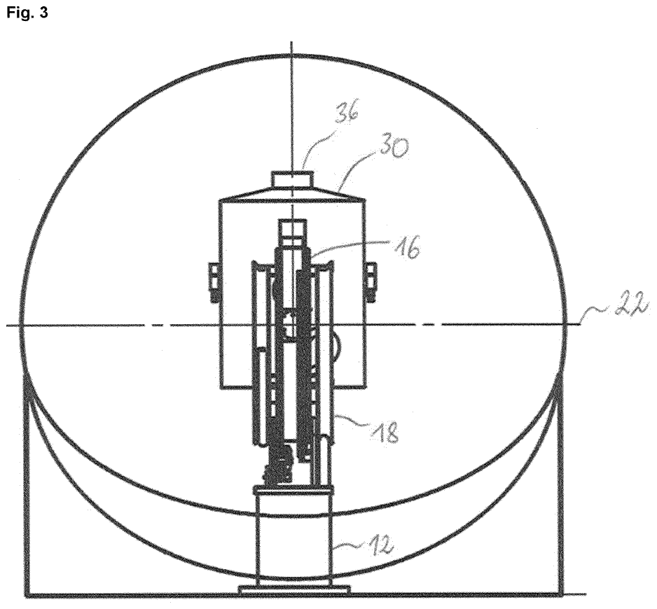

As shown in FIGS. 1 to 4, an optical ground station 10 according to a preferred embodiment of the present disclosure comprises a base 12 carrying a bearing support 14 that cooperates with circular-arc-shaped guides (C-guides) 16 fixed on an intermediate frame 18. Bearing support 14 comprises rolling-element bearing blocks 20 engaged with the C-guides 16 such that the C-guides may travel orbitally about a first, substantially horizontal, axis 22 corresponding to the axis of the C-guides 16. Orbital travel of the C-guides corresponds to angular motion of the intermediate frame 18 about the first axis. The optical ground station 10 further comprises an optical communication terminal 30 arranged in a central clearance of the intermediate frame. The optical ground station 10 is mounted to the intermediate frame 18 by rotary bearings 32 allowing angular motion of the optical communication terminal 30 about a second axis 34 intersecting the first axis 22 at right angle. The second axis is fixed in the reference frame of the intermediate frame 18 and will thus rotate together with the intermediate frame in the reference system of the base 12.

A first actuator is provided to precisely rotate the intermediate frame 18 relative to the base 12 about the first axis 22. In the illustrated embodiment, the first actuator comprises a curved linear motor 24 having a first, arc-shaped, carrier 26 with permanent magnets arranged on the intermediate frame 18 and a second carrier 28 with electromagnets arranged on the bearing support 14. The curved linear motor 24 may include a scale encoder to provide a position feedback signal. In this case, the first actuator is a (curved) linear servomotor. Instead of (or in addition to) a scale encoder, a separate scale encoder could be used to determine the angular position of the intermediate frame 18 relative to the base 12.

A second actuator is configured and arranged to rotate the optical communication terminal 30 about the second axis 34, relative to the intermediate frame 18. In the illustrated embodiment, the second actuator comprises a servomotor 33 for precise control of the angular position of the optical communication terminal 30 relative to the intermediate frame 18.

The optical ground station 10 is configured such that the intermediate frame 18 may be rotated at least 160°, preferably 180°, about the first axis and such that the optical communication terminal may be rotated at least 160°, preferably 180°, about the second axis.

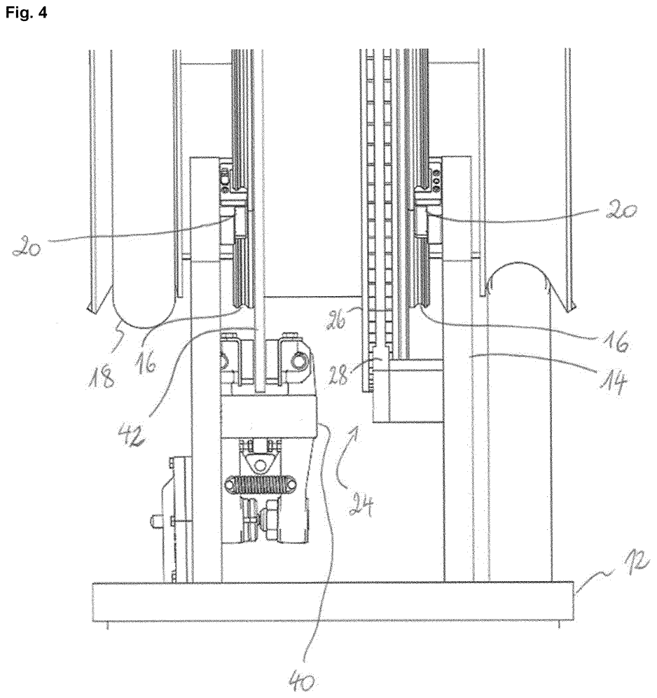

The optical ground station 10 may comprise brakes to block rotation about the first and/or the second axis. FIG. 4 shows a brake for inhibiting motion about the first axis. The brake comprises a brake caliper 40 fixed on the bearing support 14 and a brake disk segment 42 fixed on the intermediate frame 18. Another brake (not shown) may be provided for inhibiting motion of the optical communication terminal relative to the intermediate frame.

The optical communication terminal 30 comprises at least one telescope 36. In the illustrated embodiment, the optical communication terminal comprises a main telescope 36 and auxiliary telescopes 38.

The optical ground station preferably comprises a controller operatively connected (by wire and/or wirelessly) with the first and second actuators and the encoders for dynamically controlling the pointing direction of the optical communication terminal.

While a specific embodiment has been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the present disclosure, which is to be given the full breadth of the appended claims and any and all equivalents thereof.

1. An optical ground station for satellite communication, comprising
a base having a bearing support;
an intermediate frame mounted on the base, the intermediate frame comprising a circular-arc-shaped guide having an axis, the circular-arc-shaped guide engaged with the bearing support so as to allow angular motion of the intermediate frame about a first, substantially horizontal, axis corresponding to the axis of the circular-arc-shaped guide;
a first actuator configured and arranged to rotate the intermediate frame relative to the base about the first axis;
an optical communication terminal mounted to the intermediate frame and having a rotary bearing configured to allow angular motion of the optical communication terminal about a second axis perpendicular to the first axis; and
a second actuator configured and arranged to rotate the optical communication terminal relative to the intermediate frame about the second axis.

2. The optical ground station as claimed in claim 1, wherein the first actuator comprises a curved linear motor.

3. The optical ground station as claimed in claim 1, comprising a scale encoder configured to read an angular position of the intermediate frame relative to the base.

4. The optical ground station as claimed in claim 1, wherein the second actuator comprises a servomotor.

5. The optical ground station as claimed in claim 1, wherein the optical communication terminal comprises a telescope.

6. The optical ground station as claimed in claim 1, wherein the optical communication terminal comprises a set of plural telescopes.

7. The optical ground station as claimed in claim 1, comprising a controller operatively connected with the first and second actuators and configured to control a pointing direction of the optical communication terminal.

8. The optical ground station as claimed in claim 1, wherein the first axis is oriented in a North-South direction.

9. The optical ground station as claimed in claim 1, wherein the intermediate frame is configured to rotate at least 160° about the first axis.

10. The optical ground station as claimed in claim 1, wherein the optical communication terminal is configured to rotate at least 160° about the second axis.

11. The optical ground station as claimed in claim 1, wherein each one of the first and the second axes is balanced.

12. The optical ground station as claimed in claim 1, wherein the first and second axes are skew lines separated by a perpendicular distance.

13. The optical ground station as claimed in claim 12, comprising second components configured to rotate about the second axis and first components configured to rotate about the first axis, the first components including the second components, wherein the perpendicular distance between the first and second axes is chosen such that the center of mass of the first components lies on the first axis.

14. (canceled)

15. The optical ground station as claimed in claim 1, wherein the intermediate frame is configured to rotate at least 170° about the first axis.

16. The optical ground station as claimed in claim 1, wherein the optical communication terminal is configured to rotate at least 170° about the second axis.

17. An optical ground station for optical communication with a satellite in space, comprising:
a base having a bearing support;
an intermediate frame mounted on the base, the intermediate frame comprising a guide having a shape of a circular-arc about a first, substantially horizontal axis, the circular-arc-shaped guide engaged with the bearing support so as to allow angular motion of the intermediate frame about the first axis;
a first actuator configured and arranged to rotate the intermediate frame relative to the base about the first axis, the first actuator comprising a curved linear motor;
a scale encoder configured to read an angular position of the intermediate frame relative to the base;
an optical communication terminal mounted in X/Y configuration, the X/Y configuration having singularities located on the first axis, the optical communication terminal mounted to the intermediate frame and having a rotary bearing configured to allow angular motion of the optical communication terminal about a second axis perpendicular to the first axis; and
a second actuator configured and arranged to rotate the optical communication terminal relative to the intermediate frame about the second axis.

18. An optical ground station for optical communication with a satellite in space, comprising
a base having a bearing support;
a circular-arc-shaped intermediate frame mounted on the base, the intermediate frame comprising a guide engaged with the bearing support so as to allow angular motion of the intermediate frame about a first, substantially horizontal, axis corresponding to the axis of the circular-arc-shaped guide;
a first actuator configured and arranged to rotate the intermediate frame relative to the base about the first axis;
an optical communication terminal mounted in X/Y configuration, the X/Y configuration having singularities located on the first axis, the optical communication terminal mounted to the intermediate frame and having a rotary bearing configured to allow angular motion of the optical communication terminal about a second axis perpendicular to the first axis, the first and second axes being skew lines separated by a perpendicular distance; and
a second actuator configured and arranged to rotate the optical communication terminal relative to the intermediate frame about the second axis.

19. The optical ground station as claimed in claim 18, comprising second components configured to rotate about the second axis and first components configured to rotate about the first axis, the first components including the second components, wherein the perpendicular distance between the first and second axes is chosen such that the center of mass of the first components lies on the first axis.
